(19) United States
(12) Patent Application Publication
(10) Pub. No.: US 2015/0010728 A1
(43) Pub. Date: Jan. 8, 2015

(54) FOAM PRODUCT INTEGRAL WITH TRIM COVER ELEMENT

(71) Applicant: TACHI-S CO., LTD., Tokyo (JP)

(72) Inventor: Tsuyoshi TABATA, Tokyo (JP)

(21) Appl. No.: 14/303,717

(22) Filed: Jun. 13, 2014

(30) Foreign Application Priority Data
Jul. 4, 2013 (JP) 2013-140627

(51) Int. Cl. B60N 2/58

(52) U.S. Cl. CPC B60N 2/58
USPC 428/71

(57) ABSTRACT

A foam product integral with trim cover element, which is formed by injecting a liquid polyurethane material, with carbon oxide mixed therein, into an inside of the trim cover element, and curing the liquid polyurethane material into a soft foam padding filled in the trim cover element. In this kind of foam product, a material capable of impregnation with the liquid polyurethane material is attached to an inward surface of the trim cover element. This material capable of impregnation with the liquid polyurethane material is impregnated and bonded with the resulting soft foam padding during a foaming process, and is greater in hardness than the soft foam padding, sufficient to withstand shrinkage of the soft foam padding within the trim cover element. An impregnation-preventive film, or the combination of the impregnation-preventive film and a soft polyurethane open-cell foam layer, may be attached to an inward surface of the afore-said material.

### BACKGROUND OF THE INVENTION

1. Field of the Invention

The present invention relates to a foam product formed integrally with a trim cover assembly, wherein such foam product is a vehicle-seat-related foam product which includes an automotive seat, a headrest for use with the automotive seat, and an armrest for use with the automotive seat, for instance. In particular, the invention is directed to a foam product of this kind which is formed by a foaming process involving the steps of: mixing carbon oxide (CO₂) into a liquid foaming agent (i.e. a liquid polyurethane material of soft property) adapted for forming a soft urethane foam; injecting the liquid foaming agent with the carbon oxide mixed therein into the inside of a trim cover assembly; and curing such liquid foaming agent to form an increased mass of a soft foam padding filled in the trim cover assembly in an integral manner.

2. Description of Prior Art

There has been known a foaming process involving the steps of mixing carbon oxide into a liquid foaming agent containing polyurethane as one of its gradients therein and causing such liquid foaming agent with carbon oxide mixed therein to expand into a desired dimensions of urethane foam or foam padding, which is for example disclosed by Japanese Laid-Open Publication No. 2000-230066 (JP 2000-230066 A). Some of seat manufacturers utilize such foaming technique to form a foam product integral with a trim cove assembly. By way of example, a headrest may be formed, in which case, a carbon-oxide foaming process for forming the headrest entails the steps of providing a liquid polyurethane material of soft property as a liquid foaming agent, injecting the liquid foaming agent into the inside of a trim cover assembly preformed in a shape conforming to the contour of the headrest, thereafter mixing carbon oxide into the liquid forming agent, and curing the mixture thereof, so that an increased mass of soft urethan foam padding is formed and filled in the trim cover assembly in an integral manner.

The above-described foaming process for forming a soft foam product integral with trim cover assembly is based on a known low-density foaming technique using carbon oxide, which involves causing bubbly expansion of carbon oxide in a liquid foaming agent to thereby forcibly increase a volume of each of many cells created in an increased mass of foam padding (urethan foam body) within the trim cover assembly, whereby a low-density urethan foam body (i.e. low-density foam padding) integral with the trim cover assembly is obtained. However, according to this process, as the volume of each of many cells is forcibly increased, a resin structure of the resulting urethan foam is forcibly stretched and expanded, which adversely reduces a strength of the urethan foam itself. As is known, during the foaming process, the urethan foam body being created becomes swollen to a maximum degree and subsequently shrinks into a decreased dimension of a final urethan foam body, while it is being cured. Therefore, in this low-density foaming process, the resulting urethan foam, because of its reduced resin strength stated above, naturally shrinks into a small dimensions by a degree corresponding to the reduction of resin strength. As a result thereof, a plurality of objectionable creases and wrinkles are created in the surfaces of the trim cover assembly. In other words, objectionable creases and wrinkles inevitably appear in the outer surfaces of a resultant headrest.

In this conventional foam product, the fact that a resulting urethan foam expands to a maximum degree and subsequently shrinks into a small dimension corresponding to the strength reduction thereof as stated above, has given a rise to the problem that a plurality of spaces or non-contact spots are formed locally between the trim cover assembly and a resultant foam padding underlaying the trim cove assembly, thereby causing slackened or loosened areas in the trim cover assembly, with the result that a plurality of creases or wrinkles undesirably appear in the outer surfaces of the trim cover assembly. This impairs an outer aesthetic appearance of the resulting product (a headrest in this case). Another problem of this prior art is that, due to the shrinkage of urethan foam stated above, it is difficult to precisely form a preset dimension of foam padding within the trim cover assembly.

### SUMMARY OF THE INVENTION

In view of the afore-stated drawbacks, it is a primary purpose of the present invention to provide a foam product integral with trim cover assembly, which maintains the original outer shape thereof, without any crease and wrinkle created in the surfaces of the trim cover assembly, irrespective of the fact that an urethan foam expands to a maximum degree and subsequently shrinks into a small dimension at the steps of curing a corresponding liquid foaming agent with carbon oxide mixed therein.

In order to achieve such purpose, in accordance with the present invention, there is basically provided a foam product integral with a trim cover element, which is formed by mixing carbon oxide into a liquid polyurethane material of soft property, injecting the liquid polyurethane material of soft property with the carbon oxide mixed therein into an inside of the trim cover element, and curing the liquid polyurethane material of soft property into a soft foam padding filled in the trim cover element integrally, wherein the trim cover element has an inward surface facing to the inside thereof,

the foam product integral with the trim cover assembly comprising:
a material which is capable of impregnation with the liquid polyurethane material of soft property,
wherein the material is firmly attached to the inward surface of the trim cover element,
wherein the material is impregnated and bonded with the soft foam padding, and
wherein the material is greater in hardness than the soft foam padding.

Accordingly, during the steps of curing the liquid urethan foam material with carbon oxide mixed therein into an increased mass of soft foam padding within the trim cover assembly, the liquid polyurethane material, which is being cured and expanded to a maximum degree with bubbly expansion of the carbon oxide, reaches the afore-said material fixed on the inward surfaces of the trim corner element, which results in the material being impregnated with the liquid polyurethane material and bonded therewith. Consequently, the afore-said material and resultant soft foam padding are firmly, integrally bonded with each other at the impregnation area. During the foaming process, the liquid polyurethane material with carbon oxide mixed therein is cured and expanded to a maximum degree, becoming a maximum increased mass of foam padding, but subsequently, such foam padding shrinks into a relatively small body. However, since the afore-said material is greater in hardness than the soft foam padding and has been impregnated and bonded with the latter, a high hard property of such material withstands the shrinkage of the soft foam padding, so that the trim cover element is precluded thereby from being slackened and deformed, and further, creation of spaces or non-contact areas between the material and the foam padding is completely prevented, whereupon an overall outer shape of the resulting foam product is maintained in the predetermined original shape thereof. This insures to avoid appearance of any crease and wrinkle in the surfaces of the trim cover element.

As one preferred mode of the invention, the afore-said material may comprise a wadding having a high hardness. In that instance, such wadding is impregnated and bonded with the liquid polyurethane material, thereby effectively maintaining the original outer shape of the foam product, even in the process where the foam padding shrinks.

As another preferred mode of the invention, an impregnation-preventive film may be firmly attached to an inward surface of the afore-said material. This mode prevents impregnation of such material with the liquid polyurethane material during the foaming process, so that the outer surface side of the foam product integral with trim cover element is maintained in a proper soft and elastic condition that can offer a comfortable cushiony touch to a user.

As still another preferred mode of the invention, the afore-said material may comprise a wadding having a high hardness, and an impregnation-preventive film and a soft polyurethane open-cell foam layer may be firmly attached to the inward surface of such wadding. In this mode, those wadding, film and foam layer provide an increased thickness of soft elastic layer which underlies the trim cover element, so that an improved cushiony effect and softness are yielded on the side of the trim cover element, thus offering a comfortable touch to a user.

Other various features and advantages will become apparent from reading of the description, hereinafter, with reference to the accompanied drawings.

### BRIEF DESCRIPTION OF THE DRAWINGS

FIG. 1 is a sectional view showing a headrest as one exemplary mode of a foam product integral with trim cover assembly in accordance with the present invention;

FIG. 2 is an enlarged fragmentary sectional view of a principal part of the headrest shown in the FIG. 1;

FIG. 3 is an enlarged fragmentary sectional view similar to the FIG. 2, which shows a second alternative mode of a principal part of the headrest; and

FIG. 4 is an enlarged fragmentary sectional view similar to the FIG. 2, which shows a third alternative mode of a principal part of the headrest.

### DETAILED DESCRIPTION OF PREFERRED EMBODIMENT OF THE INVENTION

First of all, it should be understood that the present invention relates to a foam product integral with trim cover assembly in the field of vehicle or automotive seats, in general, and that, hereinafter, as one exemplary mode of such foam product integral with trim cover assembly, a description will be made of a headrest for use with an automotive seat.

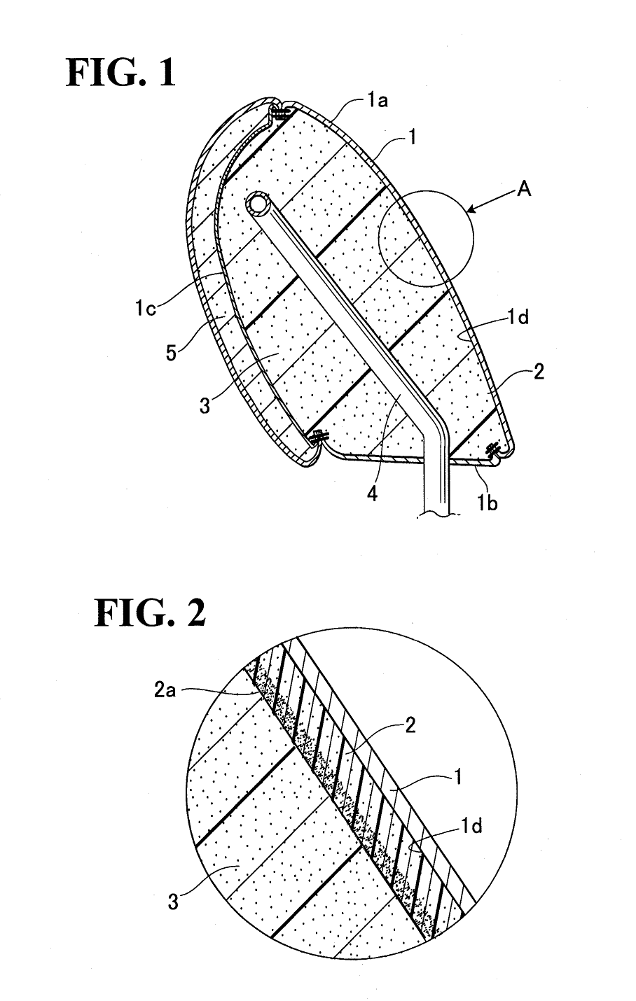

A headrest illustrated in FIG. 1 comprises: a trim cover assembly 1; a foam wadding 2 having a high hardness, which is bonded to inward surfaces 1d of the trim cover assembly 1; a foam padding 3 made of a soft urethan foam; and a headrest stay 4. The trim cover assembly 1 is formed in a three-dimensional shape conforming to a predetermined shape of the headrest, by sewing several different trim cover portions with one another. As far as the FIG. 1 is concerned, the trim cover assembly 1 is depicted to have: a rear trim cover portion la to be positioned rearwardly of the headrest; a bottom trim cover portion 1b to be positioned on a bottom side of the headrest; and a front trim cover portion 1c to be positioned forwardly of the headrest. Those rear, bottom and front trim cover portions 1a, 1b and 1c are sewn with one another, as shown, whereupon any person skilled in the art will understand that the trim cover assembly 1 assumes a predetermined three-dimensional shape. In this connection, while not shown, the trim cover assembly 1 has a pair of lateral trim cover portions which are sewn with the three trim cover portions 1a, 1b and 1c, wherein such pair of lateral trim cover portions are to be positioned on the left and right sides of the headrest, respectively. An additional cushion portion 5 is fixedly attached to an entire surface of the front trim cover portion 1c on which a head of a user is to be contacted, so that an improved cushiony comfort is given to the user's head.

In accordance with the present invention, the foam wadding 2 having a high hardness is a main indispensable element, as will be described later. In other words, generically stated, a wadding having a high hardness is used in the present invention, regardless of whether it may be made of a foam material or other suitable elastic material. Such wording, “wadding having a high hardness”, is hereby defined to be a wadding having an appropriate hardness and also having a certain elasticity, which is greater than a hardness of the foam padding 3 and also so hard and rigid enough to withstand a shrinkage of the foam padding 3 which occurs during foaming process to be set forth later. Hence, the wadding per se is not deformed by the shrinkage of foam padding 3. This definition is therefore applied to the illustrated foam wadding 2 having a high hardness.

Now, in conjunction with FIG. 1, reference is made to FIG. 2 which shows a first exemplary mode of the headrest, wherein the foam wadding 2 having a high hardness (hereinafter, “high-hardness foam wadding 2”) is firmly bonded, as by a proper adhesive agent, to an inward surface of the rear trim cover portion 1a, an inward surface of the bottom trim cover portion 1b, and an inward surface of the front trim cover portion 1c, wherein the “inward surface” of each of those trim cover portions 1a, 1b and 1c faces to the inside of the trim cover assembly 1. It is noted here that the bonding of the high-hardness foam wadding 2 to the trim cover portions 1a, 1b and 1c may be otherwise effected appropriately, such as by a pressure bonding or a thermal bonding. Although not shown, the high-hardness foam wadding 2 is also bonded to each inward surface of the afore-said pair of right and left lateral trim cover portions. All the inward surfaces of the rear, bottom and front trim cover portions 1a, 1b and 1c as well as the inward surfaces of the two lateral trim cover portions constitute an entire inward surface of the trim cover assembly 1. In this regard, the entire inward surface of the trim cover assembly 1 is generally designated by 1d in the Figures.

The purpose of the high-hardness foam wadding 2 thus bonded to the entire inner surface of the trim cover assembly 1 is to prevent the trim cover assembly 1 against deformation due to a shrinkage of urethan foam or foam padding 3 occurring subsequent to a maximum expansion of the same, during the foaming process. The high-hardness foam wadding 2 is approx. 0.5 to 5 mm in thickness, and made of a hard or high-density foam material that can be impregnated with a liquid foaming agent (a liquid polyurethane material), insofar as the foregoing definition applies thereto.

As normally done in the art, the above-constructed trim cove assembly 1 is placed in a proper foaming die apparatus, and a liquid foaming agent (i.e. liquid polyurethane material of soft property) is injected into the inside o the trim cover assembly 1. Thereafter, a carbon oxide is mixed into such liquid foaming agent, followed by the steps of curing the liquid foaming agent with the carbon oxide mixed therein into an increased mass of soft foam padding 3 within the trim cover assembly 1. At this point, the liquid foaming agent or liquid polyurethane material, which is being cured and expanded to a maximum degree with bubbly expansion of the carbon oxide, reaches the high-hardness foam wadding 2 fixed on the inward surface 1d of the trim cover assembly 1, which results in the wadding 2 being impregnated with the liquid polyurethane material and bonded therewith. Referring to FIG. 2, such impregnation and bonding can be recognized by the densely-dotted dark area in the high-hardness foam warding 2. Consequently, the high-hardness foam wadding 2 and resultant foam padding 3 are firmly, integrally bonded with each other at the impregnation area indicated by the densely-dotted dark area in FIG. 2. In this regard, during the foaming process, the liquid polyurethane material with carbon oxide mixed therein is cured and expanded to a maximum degree, becoming a maximum increased mass of foam padding 3, but subsequently, such foam padding 3 shrinks into a relatively small body due to escape of the carbon oxide therefrom. However, as stated above, the high-hardness foam wadding 2, greater in hardness than the soft foam padding 3, has been impregnated and bonded with the foam padding 3, and therefore, a high hard property of that wadding 2 withstands the shrinkage of the foam padding 3, so that the trim cover assembly 1 is precluded by the high-hardness foam wadding 2 from being slackened and deformed, and further, creation of spaces or non-contact areas between that wadding 2 and the foam padding 3 is completely prevented, whereupon an overall outer shape of the resulting foam product or headrest is assuredly maintained in the predetermined original shape thereof. This avoids any crease and wrinkle from appearing in the surfaces of the trim cover assembly 1.

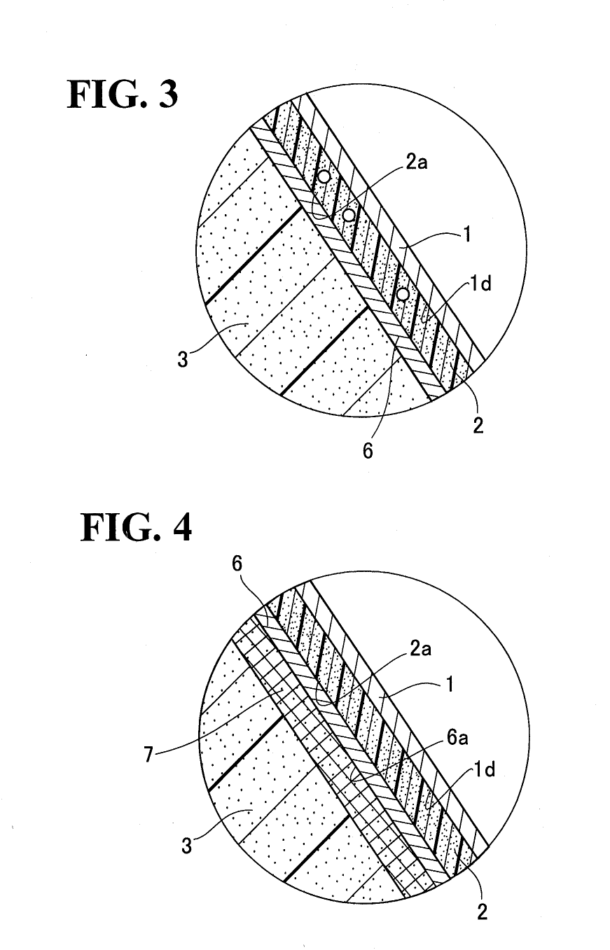

FIGS. 3 and 4 show second and third alternative modes as applied to the headrest described above, respectively. Each of the FIGS. 3 and 4 is an enlarged sectional view of a principal part thereof, as similar to FIG. 2. It is noted that all like designations in the FIGS. 3 and 4 correspond to all like designations in FIGS. 1 and 2, and any further detailed description is omitted as to the common parts and elements found thereamong, for the sake of simplicity.

According to the second mode of FIG. 3, likewise as in the first mode of FIG. 1, the foregoing high-hardness foam wadding 2 is bonded to the inward surface 1d of the trim cover assembly 1. In the present mode, attached to the inward surface 2a of the high-hardness foam wadding 2 is an impregnation-preventive film 6 having a certain elasticity. This film 6 is adapted to prevent invasion of the liquid foaming agent into the high-hardness foam wadding 2 during the steps of causing curing and expansion of the liquid foaming agent to a maximum degree, thereby preventing the high-hardness foam wadding 2 from being impregnated with the liquid foaming agent. In other words, in the previous first mode, the impregnation area in that wadding 2, as indicated by the densely-dotted dark area in FIG. 2, results in providing a relatively hard area which is harder than the foam padding 3. This causes an objectionable hardness on the side of the trim cover assembly 1 and therefore gives discomfort to a user, which apparently degrades the cushiony property of the foam product or the headrest. To solve the problem, in the present second mode, the impregnation-preventive film 6 having a certain elasticity is interposed between the high-hardness foam wadding 2 and foam padding 3. With such arrangement, it is possible to avoid formation of the afore-said hard impregnation area in the high-hardness foam wadding 2, so that the outer layer region of the headrest, corresponding to both trim cover assembly 1 and wadding 2, is maintained in a proper soft and elastic condition that can offer a comfortable cushiony touch to a user.

FIG. 4 illustrates a third mode which is basically identical in structure to the foregoing second mode of FIG. 3, except that a soft polyurethane open-cell foam layer 7 is attached to an inward surface 6a of the aforementioned impregnation-preventive film 6. This soft polyurethane open-cell foam layer 7 is approx. 0.5 to 5.0 mm in thickness, and the purpose thereof is to prevent the above-stated hardening of the high-hardness foam wadding 2 which occurs due to the impregnation of the same 2 with the liquid foaming agent. In the present mode, those wadding 2, film 6a, and foam layer 7 in the aggregate provide an increased thickness of soft elastic layer which underlies the trim cover assembly 1, so that an improved cushiony effect and softness are yielded on the side of the trim cover assembly 1, thus offering a comfortable touch of outer surfaces of the foam product or headrest to a user.

While having described the present invention as above, it should be understood that the invention is not limited to the illustrated embodiment, but any modification, replacement and addition may be applied thereto, without departing from the scope of the appended claims. For example, since the invention relates to a foam product integral with trim cover assembly in general, it can be applied to an automotive seat or an armrest for use with an automotive seat, instead of the above-described headrest. Further, while the above descriptions have been made as to attachment of the high-hardness foam wadding 2, or a relatively hard wadding material capable of impregnation with a liquid foaming agent, to the entire inward surface 1d of the trim cover assembly 1 which includes all the inward surfaces of the rear, bottom and front trim cover portions 1a, 1b and 1c, it should be understood that such wadding material capable of impregnation with a liquid foaming agent may only be provided to a particular localized area(s) of the trim cover assembly's inward surface 1d which is/are prone to deformation or causing creases due to the shrinkage of the foam padding 3.

What is claimed is:

1. A foam product integral with a trim cover element, which is formed by mixing carbon oxide into a liquid foaming agent which is a basic material for forming a polyurethane foam of soft property, injecting said liquid foaming agent with said carbon oxide mixed therein into an inside of said trim cover element, and curing said liquid foaming agent into a soft foam padding filled in said trim cover element integrally, wherein said trim cover element has an inward surface facing toward the inside thereof,
said foam product integral with the trim cover assembly including a material which is capable of impregnation with said liquid foaming agent,
wherein said material is firmly attached to said inward surface of said trim cover element,
wherein said material is impregnated and bonded with said soft foam padding, and
wherein said material is greater in hardness than said soft foam padding.

2. A foam product integral with a trim cover element as claimed in claim 1, wherein said material comprises a wadding having a high hardness.

3. A foam product integral with a trim cover element as claimed in claim 1, wherein said material has an inward surface facing toward the inside of said trim cover element, and wherein an impregnation-preventive film is firmly attached to said inward surface of said material.

4. A foam product integral with a trim cover element as claimed in claim 1, wherein said material comprises a wadding having a high hardness, wherein said wadding has an inward surface facing toward the inside of said trim cover element, and wherein an impregnation-preventive film is firmly attached to said inward surface of said wadding.

5. A foam product integral with a trim cover element as claimed in claim 1, wherein said material has an inward surface facing toward the inside of said trim cover element, and wherein an impregnation-preventive film and a soft polyurethane open-cell foam layer are firmly attached to said inward surface of said material.

6. A foam product integral with a trim cover element as claimed in claim 1, wherein said material comprises a wadding having a high hardness, wherein said wadding has an inward surface facing toward the inside of said trim cover element, and wherein an impregnation-preventive film and a soft polyurethane open-cell foam layer are firmly attached to said inward surface of said wadding.
